(19) United States
(12) Patent Application Publication
(10) Pub. No.: US 2026/0111697 A1
(43) Pub. Date: Apr. 23, 2026

(54) OPTICAL LAMINATE

(71) Applicant: NITTO DENKO CORPORATION, Osaka (JP)

(72) Inventors: Masato KATSUDA, Osaka (JP); Yudai NUMATA, Osaka (JP); Shoichi MATSUDA, Osaka (JP)

(73) Assignee: NITTO DENKO CORPORATION, Osaka (JP)

(21) Appl. No.: 19/114,628

(22) PCT Filed: Sep. 22, 2023
(86) PCT No.: PCT/JP2023/034397

§ 371 Date: Mar. 24, 2025

(30) Foreign Application Priority Data
Sep. 30, 2022 (JP) 2022-157759

(51) Int. Cl. G06K 19/06; G02B 5/20; G02B 5/28

(52) U.S. Cl. CPC G06K 19/0614; G02B 5/206; G02B 5/208; G02B 5/281; G06K 19/06037; G06K 19/06131

(57) ABSTRACT

This optical stack has a first main surface and a second main surface that is on the opposite side from the first main surface, wherein: the optical stack includes an optical filter layer that transmits infrared rays and reflects visible light, and a diffusion layer that diffuses visible light; the reflectivity with respect to infrared rays having a wavelength of 850 nm is 66%; and when the second main surface is disposed on a pattern that is readable using infrared rays, the pattern being formed on a foundation having a backscatter rate of 19%, the pattern can be read using infrared rays from the first-main-surface side.

### TECHNICAL FIELD

The present invention relates to an optical stack.

### BACKGROUND ART

Today, AR (Augmented Reality) markers such as barcodes, QR codes (registered trademark), ArUco markers, chameleon codes and the like are used for various uses (e.g., Patent Document 1). An AR marker is usually provided at a position where a user can see, and therefore, the external appearance or design of an item (printed matter, etc.) provided with the AR marker is spoiled.

In addition, such an AR marker is accessible by anybody, and therefore, cannot be used for the purpose of, for example, conveying confidential information.

Patent Documents 2 and 3 each disclose a method by which toner absorbing or reflecting infrared light is used to form an image that is not easily visually recognized by visible light in a state where such an image overlaps an image visually recognizable by the visible light.

### CITATION LIST

### Patent Literature

Patent Document No. 1: Japanese Laid-Open Patent Publication No. 2016-224485
Patent Document No. 2: Japanese Laid-Open Patent Publication No. 2018-132720
Patent Document No. 3: Japanese Laid-Open Patent Publication No. 2020-154305

### SUMMARY OF INVENTION

### Technical Problem

However, the method described in each of Patent Documents 2 and 3 is for forming an image that is not easily visually recognized by the visible light in a state where such an image overlaps an image visually recognizable by the visible light, and therefore, is not usable for a variety of uses. In addition, the toner absorbing or reflecting infrared light is not completely transparent. Therefore, there is a limitation on the graphical pattern to be included in the image that is to overlap an image visually recognizable by the visible light. There is another problem that the above-described methods are not usable for an entirely white image.

A pattern (e.g., an AR marker) formed by use of toner (or ink) absorbing or reflecting infrared light may be formed on surfaces of items and on building components (e.g., walls, floors, and windows) as well as on recording medium layers formed of paper or the like. According to studies made by the present inventors, such a pattern formed of the toner absorbing or reflecting the infrared light may possibly be unreadable in the case where the underlying layer on which the pattern is formed is of a certain type.

Thus, the present invention has an object of providing an optical stack that, even when disposed on an infrared-readable pattern formed on any of various types of underlying layers, enables the pattern to be read by the infrared light. The present invention also has an object of providing an optical stack that makes it difficult to visually recognize the pattern, thereby enabling various designs to be applied.

In this specification, an infrared-readable pattern is not limited to an AR marker described above as an example, and may include any of designs in general including illustrations, letters, motifs, colors and the like.

### Solution to Problem

Embodiments of the present invention provide the solutions described in the following items.

### [Item 1]

An optical stack having a first main surface and a second main surface on the opposite side to the first main surface, the optical stack comprising:
an optical filter layer transmitting infrared light and reflecting visible light; and
a diffusion layer diffusing the visible light,
wherein when disposed on an infrared-readable pattern formed on an underlying layer having a reflectance of 66% and a backscattering ratio of 19% for infrared light having a wavelength of 850 nm such that the second main surface faces the pattern, the optical stack enables the pattern to be read by the infrared light from the side of the first main surface.

### [Item 2]

The optical stack of item 1, wherein when disposed on an infrared-readable pattern formed on an underlying layer having a reflectance of 66% and a backscattering ratio of 10% for infrared light having a wavelength of 850 nm such that the second main surface faces the pattern, the optical stack enables the pattern to be read by the infrared light from the side of the first main surface.

### [Item 3]

The optical stack of item 1, wherein when disposed on an infrared-readable pattern formed on an underlying layer having a reflectance of 66% and a backscattering ratio of 1% for infrared light having a wavelength of 850 nm such that the second main surface faces the pattern, the optical stack enables the pattern to be read by the infrared light from the side of the first main surface.

### [Item 4]

The optical stack of any one of items 1 through 3, wherein the optical stack has a backscattering ratio that is lower than 10% for near infrared light.

### [Item 5]

The optical stack of any one of items 1 through 4, wherein the optical stack has a forward scattering ratio of 9% or higher for near infrared light.

### [Item 6]

The optical stack of any one of items 1 through 5, further comprising a visible light absorbing layer transmitting the infrared light and absorbing the visible light.

### [Item 7]

The optical stack of any one of items 1 through 6, further comprising a decorative layer disposed on the side of the first main surface with respect to the optical filter layer.

### [Item 8]

The optical stack of any one of items 1 through 7, wherein the diffusion layer includes particles.

### [Item 9]

The optical stack of any one of items 1 through 8, wherein the optical stack has a backscattering ratio of 30% or higher for the visible light and a forward scattering ratio of 5% or lower for the visible light

### [Item 10]

The optical stack of any one of items 1 through 9, wherein the optical filter layer includes a visible light-transflective layer.

### [Item 11]

The optical stack of any one of items 1 through 9, wherein the optical filter layer has x and y coordinates respectively in the ranges of 0.25≤x≤0.40 and 0.25≤y≤0.40 on a CIE 1931 chromaticity diagram where the standard light is from a D65 light source.

### [Item 12]

The optical stack of item 11, wherein the optical filter layer has a linear transmittance of 60% or higher for light having a wavelength in at least a part of the range that is not shorter than 760 nm but not longer than 2000 nm.

### [Item 13]

The optical stack of item 11 or 12, wherein the optical filter layer includes a matrix and microparticles dispersed in the matrix, the microparticles acting as light-scattering mediums.

### [Item 14]

The optical stack of any one of items 11 through 13, wherein the microparticles form at least a colloidal amorphous array.

### Advantageous Effects of Invention

According to an embodiment of the present invention, an optical stack is provided that is disposed on an infrared-readable pattern formed on various surfaces, thereby enabling various designs to be applied.

### BRIEF DESCRIPTION OF DRAWINGS

FIG. 1 is a schematic cross-sectional view of an optical stack 100A according to an embodiment of the present invention.

FIG. 2 is a schematic cross-sectional view of an optical stack 100B according to an embodiment of the present invention.

FIG. 3 is a schematic cross-sectional view of an optical stack 100C according to an embodiment of the present invention.

FIG. 4 is a plan view showing an example of pattern 12p readable by infrared light.

FIG. 5 is a schematic cross-sectional view of an optical filter layer 110.

FIG. 6 shows an example of cross-sectional TEMP image of the optical filter layer 110.

FIG. 7 is a graph normalized with the maximum transmittance, showing an example of incident angle dependence of the linear transmittance spectrum of the optical filter layer 110.

FIG. 8 is a schematic view illustrating optical characteristics of an optical stack according to an embodiment of the present invention.

FIG. 9 is a schematic view showing a method for measuring the diffuse transmittance of an optical stack.

FIG. 10 is a schematic view showing a method for measuring the linear transmittance of an optical stack.

FIG. 11 is a schematic view showing a method for measuring the reflectance of an optical stack.

FIG. 12 is a schematic view showing a method for measuring the backscattering ratio of an optical stack.

FIG. 13 is a schematic view showing a method for evaluating the infrared-readability of a QR code.

FIG. 14A is an optical image of an optical stack in comparative example 2.

FIG. 14B is an infrared image of the QR code observed by an infrared camera through the optical stack in comparative example 2.

FIG. 15A is an optical image of an optical stack in comparative example 4.

FIG. 15B is an infrared image of the QR code observed by the infrared camera through the optical stack in comparative example 4.

FIG. 16A is an optical image of an optical stack in example 10.

FIG. 16B is an infrared image of the QR code observed by the infrared camera through the optical stack in example 10.

### DESCRIPTION OF EMBODIMENTS

Hereinafter, an optical stack according to an embodiment of the present invention will be described with reference to the drawings. Embodiments of the optical stack of the present invention are not limited to the embodiment described below.

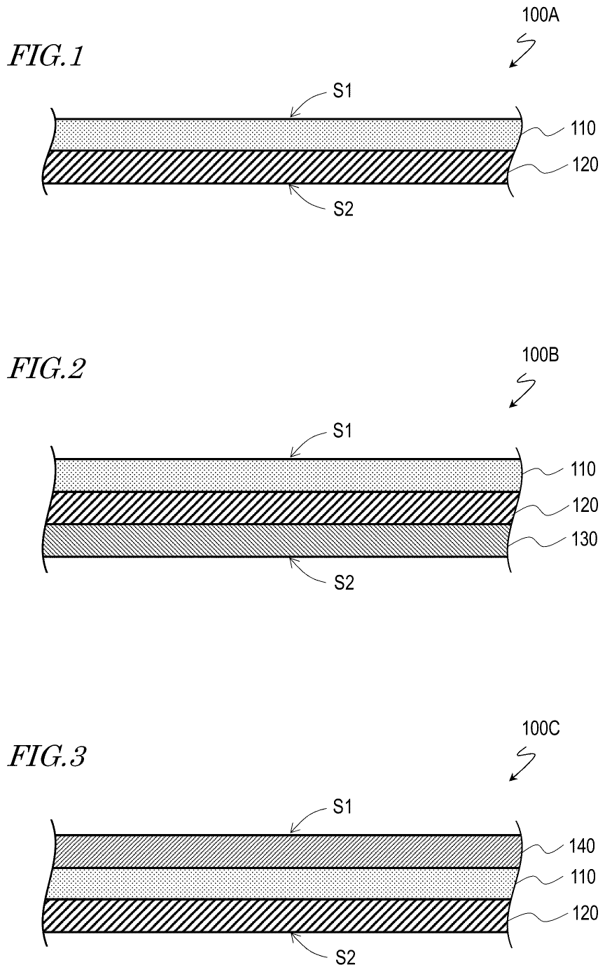

FIG. 1 is a schematic cross-sectional view of an optical stack 100A according to an embodiment of the present invention. The optical stack 100A has a first main surface (front surface) S1 and a second main surface (rear surface) S2 disposed on the opposite side to the first main surface S1. The optical stack 100A includes an optical filter layer 110 transmitting infrared light and reflecting visible light, and a diffusion layer 120 diffusing the visible light. The positional relationship between the optical filter layer 110 and the diffusion layer 120 may be opposite in the up-down direction to the one shown here.

FIG. 2 is a schematic cross-sectional view of an optical stack 100B according to an embodiment of the present invention. The optical stack 100B includes a visible light absorption layer 130 transmitting the infrared light and absorbing the visible light in addition to the optical filter layer 110 and the diffusion layer 120. The visible light absorption layer 130 is, for example, an infrared-transmissive black layer. The positional relationship between the diffusion layer 120 and the visible light absorption layer 130 may be opposite in the up-down direction to the one shown here. Note that in the case where the visible light absorption layer 130 is disposed on the side of the second main surface S2, the effect of concealing a visually recognizable pattern formed on an underlying layer is higher.

FIG. 3 is a schematic cross-sectional view of an optical stack 100C according to an embodiment of the present invention. The optical stack 100C includes a decorative layer 140 disposed on the side of the first main surface with respect to the optical filter layer 110, in addition to the optical filter layer 110 and the diffusion layer 120. In the case where the decorative layer 140 is provided, an infrared-readable pattern may be made visually unrecognizable without the external appearance or the design, of an item provided with the pattern, being spoiled, for example. The decorative layer 140 may have any of designs such as a illustrations, letters, motifs, colors and the like.

The optical stacks 100A, 100B and 100C may each include a transparent optical adhesive layer between adjacent layers among the optical filter layer 110, the diffusion layer 120, the visible light absorption layer 130 and the decorative layer 140 as necessary. The optical stacks 100A, 100B and 100C may each further include a surface protective layer on the side of the first main surface S1. The surface protective layer may be, for example, a hard coat layer, an antifouling layer, a reflection-preventive layer, and/or an anti-glare layer, and may include a single layer or a stack of two or more layers.

As shown by example experiments below, in a state where each of the optical stacks 100A, 100B and 100C according to the embodiments of the present invention is disposed on an infrared-readable pattern formed on an underlying layer having a reflectance of 66% and a backscattering ratio of 19% for infrared light having a wavelength of 850 nm such that the second main surface S2 faces the pattern, each of the optical stacks 100A, 100B and 100C enables the pattern to be read by the infrared light from the side of the first main surface S1. By contrast, optical stacks in comparative examples are as follows. In a state where the optical stack in each of the comparative examples is disposed on an infrared-readable pattern formed on an underlying layer, such as paper or the like, having a high reflectance for infrared light having a wavelength of 850 nm such that a second main surface S2 thereof faces the pattern, the optical stack enables the pattern to be read by the infrared light from the side of the first main surface S1. However, in a state where the optical stack in each of the comparative examples is disposed on an infrared-readable pattern formed on an underlying layer having a reflectance of 66% and a backscattering ratio of 19% for infrared light having a wavelength of 850 nm such that the second main surface S2 faces the pattern, the optical stack does not enable the pattern to be read by the infrared light from the side of the first main surface S1.

In addition, the optical stacks 100A, 100B and 100C according to the embodiments of the present invention each enable an infrared-readable pattern to be read by the infrared light from the side of the first main surface S1, even where the pattern is formed on an underlying layer having a reflectance of 66% and a backscattering ratio of 10% for infrared light having a wavelength of 850 nm or is formed on an underlying layer having a reflectance of 66% and a backscattering ratio of 1% for infrared light having a wavelength of 850 nm. That is, each of the optical stacks 100A, 100B and 100C according to the embodiments of the present invention, when disposed on an infrared-readable pattern formed on any of various types of underlying layers, enables any of various designs to be provided on the pattern.

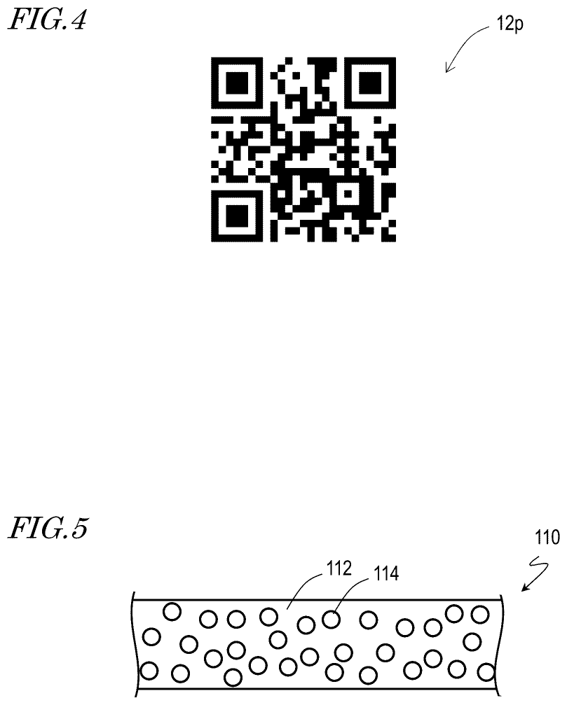

The infrared-readable pattern disposed on an underlying layer may be, for example, a pattern including information, for example, an AR marker such as a QR code or the like, e.g., a pattern 12p, a plan view of which is shown in FIG. 4, or may be a general design (encompassing, for example, an illustration, a letter, a motif, and a color). The optical stacks 100A, 100B and 100C are each typically sheet-like. Herein, the term “sheet-like” is used to encompass “plate-like” and “film-like”, with no limitation on the rigidity (flexibility) or the thickness of the sheet.

FIG. 4 is a plan view of a QR code as an example of the pattern 12p readable by the infrared light. The pattern 12p is formed of, for example, infrared-absorbing ink. The infrared-absorbing ink contains, for example, carbon, oil-based ink, dye or pigment, and any of a wide range of commercially available products of such ink may be used. Alternatively, the pattern 12p may be formed of retro-reflective ink (e.g., retro-reflective paint Bright Coat Water-based N type produced by Komatsu Process Co., Ltd.). Still alternatively, the pattern 12p may be produced by cutting a portion corresponding to the pattern 12p from a prism-type retro-reflective sheet (Nikkalite crystal grade CRG-CF series produced by Nippon Carbide Industries Co. Inc.) or a bead-type retro-reflective sheet (Nikkalite RS series produced by Nippon Carbide Industries Co. Inc.). Still alternatively, the pattern 12p may be formed by printing infrared-absorbing ink on a retro-reflective sheet.

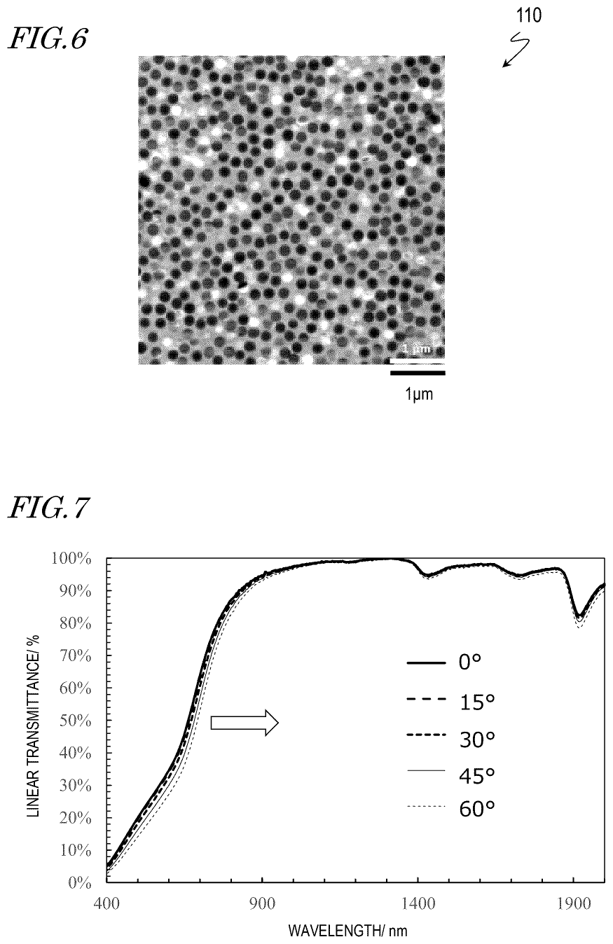

As described with reference to FIG. 5, FIG. 6 and FIG. 7, an optical filter described in International Publication WO2021/187430 filed by the present Applicant may be preferably used as the optical filter layer 110. The optical filter layer 110 is not limited to this, and may be any optical filter that has a high linear transmittance for infrared light and a relatively low diffuse transmittance for visible light. In this specification, the term “infrared light” encompasses at least light (electromagnetic waves) having a wavelength in the range that is not shorter than 760 nm but not longer than 2000 nm. The term “visible light” refers to light having a wavelength in the range that is not shorter than 400 nm and shorter than 760 nm.

Now, with reference to FIG. 5, FIG. 6 and FIG. 7, the optical filter layer 110 will be described in detail.

The optical filter layer 110 preferably usable in an optical stack according to an embodiment of the present invention includes a matrix and microparticles dispersed in the matrix. The microparticles form at least a colloidal amorphous array. The optical filter layer 110 has a linear transmittance of 60% or higher for light having a wavelength in at least a part of the range that is not shorter than 780 nm but not longer than 2000 nm. For example, the optical filter layer 110 having a linear transmittance of 60% or higher for light having a wavelength of 950 nm and light having a wavelength of 1550 nm may be provided. Light (i.e., near infrared light) for which the linear transmittance of the optical filter layer 110 is 60% or higher is preferably in a wavelength range that is, for example, not shorter than 810 nm but not longer than 1700 nm, and is more preferably in a wavelength range that is not shorter than 840 nm but not longer than 1650 nm. Herein, it is preferred that the matrix and the microparticles are both transparent to the visible light (hereinafter, referred to simply as “transparent”). The optical filter layer 110 may exhibit white.

The optical filter layer 110 includes the colloidal amorphous array. The colloidal amorphous array is an array of colloidal particles (particle size: 1 nm to 1 μm) that does not have a long-range order and does not cause Bragg reflection. This is in contrast to a case where colloidal particles are distributed so as to have a long-range order, as a result of which, a so-called colloidal crystal (a type of photonic crystal) is generated to cause Bragg reflection. That is, the microparticles (colloidal particles) included in the optical filter layer 110 do not form a diffraction grating.

The microparticles included in the optical filter layer 110 include monodispersed microparticles having an average particle size that is at least 1/10 of the wavelength of the infrared light. That is, the average particle size of the microparticles is preferably at least 80 nm or longer, more preferably 150 nm or longer, and still more preferably 200 nm or longer for the infrared light having a wavelength in the range that is not shorter than 780 nm but not longer than 2000 nm. The microparticles may include two or more types of monodispersed microparticles having different average particle sizes from each other. It is preferred that each of the microparticles is substantially spherical. In this specification, the term “microparticles” (plural) is used also to refer to an array of microparticles, and the term “monodispersed microparticles” refers to microparticles having a coefficient of variation (standard deviation/average particle size, represented by the percentage) of 20% or lower, preferably 10% or lower, and more preferably 1 to 5%. The optical filter layer 110 uses the particles having a particle size (particle diameter, equivalent volume diameter) that is at least 1/10 of the wavelength, and thus increases the linear transmittance for the infrared light.

Herein, the average particle size was found based on a three-dimensional SEM image. Specifically, Helios G4 UX produced by FEI Company was used as a focused ion beam scanning electron microscope (hereinafter, referred to as the “FIB-SEM”) to acquire successive cross-sectional SEM images. Positions of the successive images were corrected, and then a three-dimensional image was re-constructed. In more detail, the acquisition of the cross-sectional backscattered electron image by use of the SEM and processing by the FIB (acceleration voltage: 30 kV) were repeated 100 times with an interval of 50 nm, and thus the three-dimensional image was re-constructed. The obtained three-dimensional image was binarized by use of the Segmentation function of analysis software (AVIZO produced by Thermo Fisher Scientific Inc.), and thus an image of the microparticles was extracted. Next, a Separate object operation was performed in order to identify each of the microparticles, and then the volume of each microparticle was calculated. Assuming that each microparticle was spherical, the equivalent volume diameter of each microparticle was calculated. A value found by averaging the particle sizes of the microparticles was set as an average particle size.

Regarding the optical filter layer 110, either one of: the refractive indices of the microparticles and the matrix, the average particle size of the microparticles, the volume fraction of the microparticles, the distribution (degree of aperiodicity) of the microparticles, and the thickness of the optical filter layer 110 is adjusted such that the optical filter layer 110 has a linear transmittance of 60% or higher for light having a wavelength in at least a part of the range that is not shorter than 780 nm but not longer than 2000 nm.

The optical filter layer 110 may exhibit white. Herein, the term “white” refers to colors having x and y coordinates respectively in the ranges of 0.25≤x≤0.40 and 0.25≤y≤0.40 on a CIE 1931 chromaticity diagram where the standard light is from a D65 light source. Needless to say, the degree of whiteness is higher as the x and y coordinates are closer to x=0.333 and y=0.333. The x and y coordinates are preferably 0.28≤x≤0.37 and 0.28≤y≤0.37, and more preferably 0.30≤x≤0.35 and 0.30≤y≤0.35. The value of L* measured by an SCE method on a CIE 1976 color space is preferably 20 or greater, more preferably 40 or greater, still more preferably 50 or greater, and especially preferably 60 or greater. When the value of L* is 20 or greater, the color may be considered as generally white. The upper limit of the value L* is, for example, 100.

FIG. 5 is a schematic cross-sectional view of the optical filter layer 110. The optical filter layer 110 includes a matrix 112 transparent to the visible light, and transparent microparticles 114 dispersed in the transparent matrix 112. The microparticles 114 behave as light-scattering mediums. The optical filter layer 110 includes a layer having the microparticles 114, acting as the light-scattering mediums, dispersed in the matrix 112. The microparticles 114 may form, for example, at least a colloidal amorphous array. In this case, the optical filter layer 110 may include other microparticles that do not disturb the colloidal amorphous array formed by the microparticles 114.

As schematically shown in FIG. 5, the optical filter layer 110 has a substantially flat surface. Herein, the expression “substantially flat surface” refers to a surface that does not have a concaved and convexed structure of such a size as to scatter (diffract) or diffusedly reflect the visible light or the infrared light. The optical filter layer 110 is, for example, film-like but is not limited to this.

The transparent microparticles 114 are, for example, silica microparticles. As the silica microparticles, silica microparticles synthesized by, for example, a Stober method may be used. As the microparticles, inorganic microparticles other than silica microparticles may be used. Resin microparticles may be used. As the resin microparticles, for example, microparticles formed of at least one of polystyrene and poly(methyl methacrylate) are preferred. Microparticles formed of crosslinked polystyrene, crosslinked poly(methyl methacrylate) or crosslinked styrene-methyl methacrylate copolymer are more preferred. As such microparticles, for example, polystyrene microparticles or poly(methyl methacrylate) microparticles synthesized by emulsion polymerization may be used where appropriate. Hollow silica microparticles and hollow resin microparticles containing air may also be used. Microparticles formed of an inorganic material are advantageous in being high in heat resistance and light resistance. The volume fraction of the microparticles with respect to the entirety of the layer (including the matrix and the microparticles) is preferably, not lower than 6% but not higher than 60%, more preferably, not lower than 20% but not higher than 50%, and still more preferably, not lower than 20% but not higher than 40%. The transparent microparticles 114 may have optical isotropy.

The matrix 112 may be formed of, for example, acrylic resin (e.g., poly(methyl methacrylate), poly(methyl acrylate)), polycarbonate, polyester, poly(diethyleneglycolbisallylcarbonate), polyurethane, epoxy resin, polyimide or the like, but is not limited to being formed of any of these. The matrix 112 is preferably formed of a curable resin (thermosetting or photocurable), and is preferably formed of a photocurable resin from the point of view of mass-productivity. As the photocurable resin, any of various types of (meth)acrylate may be used. It is preferred that the (meth)acrylate contains a bifunctional or at least tri-functional (meth)acrylate. It is preferred that the matrix 112 has optical isotropy. In the case where a curable resin containing a polyfunctional monomer is used, the matrix 112 having a crosslinked configuration is provided, which may improve the heat resistance and the light resistance.

In the case where the matrix 112 is formed of a resin material, the optical filter layer 110 may be like a flexible film. The optical filter layer 110 has a thickness that is, for example, not less than 10 μm but not greater than 10 mm. In the case where the thickness of the optical filter layer 110 is, for example, not less than 10 μm but not greater than 1 mm, or more preferably, not less than 10 μm but not greater than 500 μm, the optical filter layer 110 may conspicuously exhibit flexibility.

In the case where the silica microparticles having a hydrophilic surface are used as the microparticles, it is preferred to form the microparticles by, for example, photocuring a hydrophilic monomer. Examples of the hydrophilic monomer include polyethyleneglycol(meth)acrylate, polyethyleneglycoldi(meth)acrylate, polyethyleneglycoltri(meth)acrylate, polypropyleneglycol(meth)acrylate, polypropyleneglycoldi(meth)acrylate, polypropyleneglycoltri(meth)acrylate, 2-hydroxyethyl(meth)acrylate, 2-hydroxypropyl(meth)acrylate, acrylamide, methylenebisacrylamide, and ethoxylated bisphenol A di(meth)acrylate, but the hydrophilic monomer is not limited to any of these. These monomers may be used independently or as a mixture of two or more thereof. Needless to say, the two or more monomers may contain a monofunctional monomer and a polyfunctional monomer, or two or more polyfunctional monomers.

These monomers may be cured by use of a photoinitiator where appropriate. Examples of the photoinitiator include carbonyl compounds such as benzoin ether, benzophenone, anthraquinone, thioxane, ketal, acetophenone and the like; sulfur compounds such as disulfide, dithiocarbamate and the like; organic peroxides such as benzoyl peroxide and the like; azo compounds; transition metal complexes; polysilane compounds; dye sensitizers; and the like. The photoinitiator is used in an amount that is preferably not smaller than 0.05 parts by mass but not larger than 3 parts by mass, and more preferably, not smaller than 0.05 parts by mass but not larger than 1 part by mass, with respect to 100 parts by mass of the mixture of the microparticles and the monomer.

Where the refractive index of the matrix with respect to the visible light is n_{M} and the refractive index of the microparticles with respect to the visible light is n_{P}, |n_{M}−n_{P}| (hereinafter, may be referred to simply as the “refractive index difference”) is preferably 0.01 or larger, preferably 0.06 or smaller, more preferably 0.03 or larger, and more preferably 0.11 or smaller. In the case where the refractive index difference is smaller than 0.03, the scattering intensity is weak and desired optical characteristics are not easily provided. In the case where the refractive index difference exceeds 0.11, the linear transmittance for the infrared light may be decreased. In the case where, for example, zirconia microparticles (refractive index: 2.13) and an acrylic resin are used to realize a refractive index difference of 0.6, the linear transmittance for the infrared light may be adjusted by decreasing the thickness. As can be seen, the linear transmittance for the infrared light may be adjusted also by, for example, controlling the thickness of the optical filter layer and the refractive index difference. When being used for a certain use, the optical filter layer may be used in a state of being stacked on an infrared-absorbing filter. The refractive index with respect to the visible light may be represented by the refractive index with respect to light having a wavelength of, for example, 546 nm. Herein, the “refractive index” is the refractive index with respect to the light having a wavelength of 546 nm, unless otherwise specified.

FIG. 6 shows a cross-sectional TEM image of the optical filer layer 110. In the TEM image in the figure, white circles are silica microparticles, and black circles are portions from which the silica microparticles have been pulled off. As represented by the cross-sectional TEM image of the optical filer layer 110, the silica microparticles are dispersed substantially uniformly.

FIG. 7 is a graph normalized by the maximum transmittance, and shows the incident angle dependence of the linear transmittance spectrum of the optical filter layer 110. The transmittance curve of the optical filter layer 110 shown in FIG. 7 includes a curved portion in which the linear transmittance monotonously increases from the visible light to the infrared light, and this curved portion is shifted (by about 50 nm) toward the longer wavelength side as the angle of incidence increases. In other words, the curved portion in which the linear transmittance monotonously decreases from the infrared light to the visible light is shifted toward the longer wavelength side as the angle of incidence increases. Such a characteristic incident angle dependence is considered to be caused by the silica microparticles included in the optical film forming the colloidal amorphous array.

The configuration, the optical characteristics and the production method of the optical filter layer 110 are described in detail in International Publication WO2021/187430 filed by the present Applicant. The entirety of the disclosure of International Publication WO2021/187430 is incorporated herein by reference. FIG. 6 and FIG. 7 show the results of example 1 in the above-mentioned international application.

A visible light-transflective layer may be used as the optical filter layer 110. The visible light-transflective layer has transmission characteristics and reflection characteristics with which the visible light-transflective layer reflects a part of the visible light incident thereon and transmits the rest of the visible light. The transmittance of the visible light-transflective layer for the visible light is preferably 10% to 70%, more preferably 15% to 65%, and still more preferably 20% to 60%. The reflectance of the visible light-transflective layer is preferably 30% or higher, more preferably 40% or higher, and still more preferably 45% or higher. For the infrared light, the visible light-transflective layer has a transmittance of preferably 10% or higher, more preferably 15% or higher, and still more preferably 20% or higher. As the visible light-transflective layer, for example, a half mirror, a reflective polarizer, a louver film, a cold mirror or the like may be used.

As the half mirror, for example, a multi-layer stack including two or more dielectric films having different refractive indices stacked on each other (also referred to as the “dielectric multi-layer film”) may be used. Such a half mirror preferably has metallic luster. Examples of materials usable to form the dielectric films include metal oxide, metal nitride, metal fluoride, thermoplastic resin (e.g., polyethyleneterephthalate (PET)) and the like. The multi-layer stack of the dielectric films reflects a part of incident light at an interface by the difference in the refractive index between the dielectric films stacked. The phase of the incident light and the reflected light is changed by the thicknesses of the dielectric films to adjust the degree of interference of the two types of light, and thus the reflectance may be adjusted. A half mirror formed of a half mirror layer stack may have a thickness that is, for example, not less than 50 μm but not greater than 200 μm. Usable examples of such a half mirror include commercially available products such as, for example, trade name “PICASUS” produced by Toray Industries Inc.

The optical characteristics of the optical stack may be evaluated as follows.

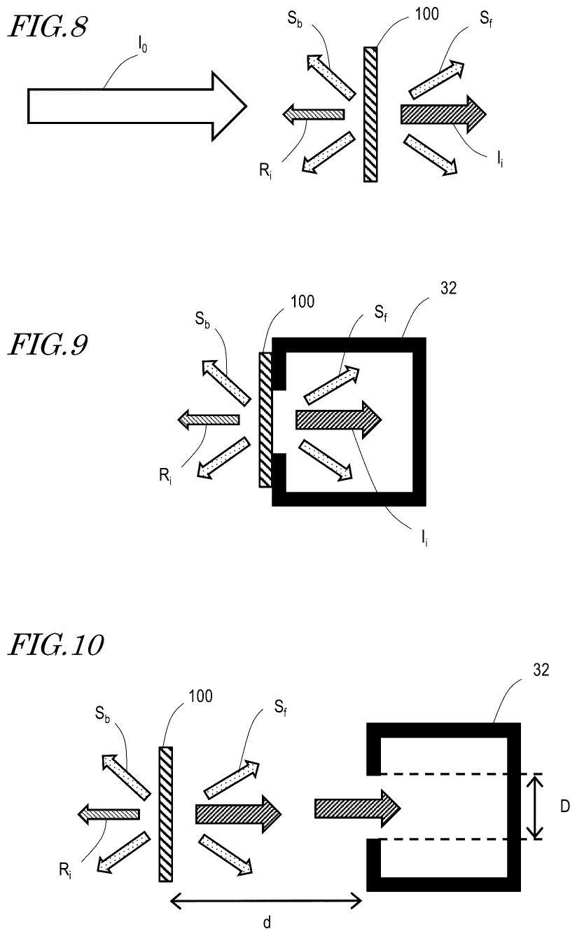

As shown in FIG. 8, when incident light I₀ is incident on the optical stack 100, a part of the incident light I₀ is transmitted through the optical stack 100 (transmitted light Iᵢ), another part of the incident light I₀ is interface-reflected (interface-reflected light Ri), and the remaining part of the incident light I₀ is scattered. Scattered light includes forward-scattered light Sf output forward with respect to the optical stack 100 and backscattered light Sb output rearward with respect to the optical stack 100. The optical stack 100 exhibits white due to the backscattered light Sb. A part of the incident light I₀ is absorbed by the optical stack 100, but the resin microparticles and the silica microparticles used herein have a small absorptance for light of 400 nm to 2000 nm.

FIG. 9 is a schematic view showing a method for measuring the diffuse transmittance of an optical filter. FIG. 10 is a schematic view showing a method for measuring the linear transmittance of an optical filter. For the diffuse transmittance, as shown in FIG. 9, the sample (optical stack 100) was disposed at an opening of an integrating sphere 32. The diffuse transmittance was found as the percentage of the total strength of the transmitted light Iᵢ and the forward-scattered light Sr with respect to the strength of the incident light I₀. The linear transmittance was measured in a state where the sample (optical stack 100) was disposed at a position 20 cm away from the opening of the integrating sphere 32. The linear transmittance was found as the percentage of the strength of the transmitted light Iᵢ obtained in this state with respect to the strength of the incident light I₀. The forward scattering ratio is found as the difference between the diffuse transmittance and the linear transmittance. The opening has a diameter of 1.8 cm, which corresponds to a solid angle of 0.025 sr.

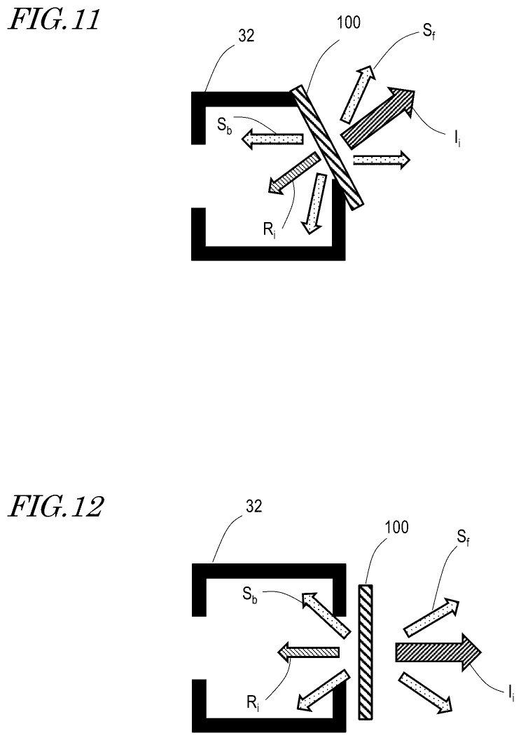

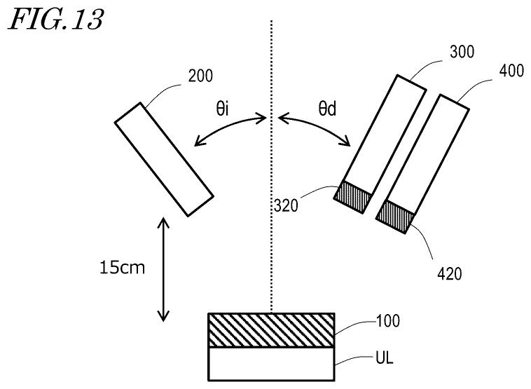

FIG. 11 is a schematic view showing a method for measuring the reflectance of an optical stack. FIG. 12 is a schematic view showing a method for measuring the backscattering ratio of an optical stack. For the reflectance, as shown in FIG. 11, the optical stack 100 was disposed obliquely at the rear-side opening of the integrating sphere 32, and the interface-reflected light Ri and the backscattered light Sb were captured in the integrating sphere 32. The reflectance was found as the percentage of the strength of the obtained light with respect to the strength of the incident light I₀. For the backscattering ratio, as shown in FIG. 12, the optical stack 100 was disposed perpendicularly at the rear-side opening of the integrating sphere 32, and only the backscattered light Sb was captured in the integrating sphere 32. The backscattering ratio was found as the percentage of the strength of the obtained light with respect to the strength of the incident light I₀. As a spectrometer, the UV-Visible/NIR Spectrophotometer UH4150 (produced by Hitachi High-Tech Corporation) was used.

The degree of whiteness of the backscattered light Sb may be measured by use of, for example, the spectrophotometer CM-2600-D (produced by Konica Minolta Inc.). The value of L* measured by the SCE (Specular Component Exclude) method and also the values of the x and y coordinates on the CIE 1931 chromaticity diagram may be found. As the value of L* is larger, and as the values of x and y are closer to 0.33, the degree of whiteness is higher.

Hereinafter, the features of the optical stack according to an embodiment of the present invention will be described by way of the example experiments (examples 1 through 11 and comparative examples 1 through 7).

As an infrared-readable pattern, a QR code (15 mm square) shown in FIG. 4 was formed by printing with black ink (BC-345XL produced by Canon Inc.). As shown in Table 1, seven types of underlying layers (A through G) different in the reflectance and the backscattering ratio were prepared.

TABLE 1

| UNDERLYING | | 850 nm | |
|---|---|---|---|
| LAYER | MATERIAL | REFLECTANCE (%) | BACK SCATTERING RATIO (%) |
| A | GLOSSY PAPER | 87.6 | 86.7 |
| B | DIELECTRIC MULTI-LAYER FILM + | 66.2 | 41.4 |
| | LIGHT-DIFFUSIVE ADHESIVE LAYER (HAZE VALUE: 80%) | | |
| C | DIELECTRIC MULTI-LAYER FILM + | 66.2 | 18.6 |
| | LIGHT-DIFFUSIVE ADHESIVE LAYER (HAZE VALUE: 50%) | | |
| D | DIELECTRIC MULTI-LAYER FILM + | 66.2 | 10.4 |
| | LIGHT-DIFFUSIVE ADHESIVE LAYER (HAZE VALUE: 30%) | | |
| E | ALUMINUM-VAPOR-DEPOSITED FILM | 82.1 | 0.8 |
| F | DIELECTRIC MULTI-LAYER FILM | 66.2 | 0.5 |
| G | BLACK INK LAYER | 9.9 | 2.1 |

As underlying layer A, glossy paper (GL-101A450 produced by Canon Inc.) was used. As each of underlying layers B through D, a layer including a dielectric multi-layer film and a light-diffusive adhesive layer disposed thereon was used. As the dielectric multi-layer film, trade name “PICASUS” produced by Toray Industries Inc. was used. As the light-diffusive adhesive layer, a layer including an acrylic tacky agent and silica microparticles dispersed therein with the Haze value being controlled (thickness: about 5 μm to 100 μm) was used. On underlying layer A, the QR code was directly formed on a surface thereof by the above-described method. As underlying layer E, an Al-vapor-deposited PET film (produced by AS ONE Corporation) was used. As underlying layer F, a dielectric multi-layer film (trade name “PICASUS” produced by Toray Industries Inc.) was used. As underlying layer G, an OHP film (CG3110 produced by 3M Company, thickness: 115 μm) with black ink (SAT-BK produced by Seiko Epson Corporation) printed thereon was used. For underlying layers B through G, the QR code formed in advance on an OHP film (CG3110 produced by 3M Company) by the above-described method was prepared, and the OHP film with the QR code formed thereon was disposed on a surface of each of underlying layers B through G.

In each of examples 1 through 10 and comparative examples 1 and 2, the optical filter layer described in the above-described international application (example 1) (hereinafter, this optical filter layer will be referred to as the “optical filter N”) was used as the optical filter layer of the optical stack. In each of example 11 and comparative examples 5, 6 and 7, a dielectric multi-layer film (trade name “PICASUS” produced by Toray Industries Inc.) was used as the optical filter layer of the optical stack.

In each of the comparative examples and the examples, the optical stack has the following configuration. An optical stack having substantially the same stack configuration as that of the optical stack 100A shown in FIG. 1 (two layers) will be referred to as “type A”, and an optical stack having substantially the same stack configuration as that of the optical stack 100B shown in FIG. 2 (three layers) will be referred to as “type B”. Herein, a transparent optical adhesive layer (OCA layer) is not counted as a layer.
Comparative example 1 one layer: optical filter N/OCA layer
Comparative example 2 type A: optical filter N/OCA layer/infrared-transmissive black layer
Comparative example 3 one layer: white PET
Comparative example 4 type A: white PET/OCA layer/infrared-transmissive black layer
Comparative example 5 type A: light-diffusive adhesive layer/dielectric multi-layer film
Comparative example 6 type A: light-diffusive adhesive layer/dielectric multi-layer film
Comparative example 7 type A: light-diffusive adhesive layer/dielectric multi-layer film
Example 1 type A: optical filter N/light-diffusive adhesive layer (H30%)
Example 2 type A: optical filter N/light-diffusive adhesive layer (H50%)
Example 3 type A: optical filter N/light-diffusive adhesive layer (H80%)
Example 4 type B: optical filter N/light-diffusive adhesive layer (H30%)/infrared-transmissive black layer
Example 5 type B: optical filter N/light-diffusive adhesive layer (H50%)/infrared-transmissive black layer
Example 6 type B: optical filter N/light-diffusive adhesive layer (H80%)/infrared-transmissive black layer
Example 7 type A: AG1/OCA layer/optical filter N
Example 8 type A: AG2/OCA layer/optical filter N
Example 9 type B: AG1/OCA layer/optical filter N/infrared-transmissive black layer
Example 10 type B: AG2/OCA layer/optical filter N/OCA layer/infrared-transmissive black layer
Example 11 type A: light-diffusive adhesive layer (H80%)/dielectric multi-layer film

Herein, the term “stack configuration” refers to a configuration of upper layer/lower layer, “H” represents the Haze value, and “AG” represents the anti-glare layer.
OCA layer: LUCIACS (produced by Nitto Denko Corporation), thickness: 25 to 100 μm
White PET: Melinex® polyester film (produced by DuPont de Nemours Inc.), thickness: 50 μm
Light-diffusive adhesive layer: layer including an acrylic tacky agent and silica microparticles dispersed therein with the Haze value being controlled, thickness: about 5 μm to 100 μm
Infrared-transmissive black layer: OHP film (CG3110 produced by 3M Company, thickness: 115 μm) with SAT-BK (produced by Seiko Epson Corporation) printed thereon
AG1: AG150 produced by Nitto Denko Corporation
AG2: PFN60 (produced by Daicel Corporation, thickness: 60 μm)

FIG. 13 is a schematic view showing a method for evaluating the infrared-readability of the QR code. The optical stack 100 disposed on each underlying layer UL was irradiated with infrared light (850 nm) from an infrared light source (SEC-IRLED-6B produced by Kabushiki Kaisha Broadwatch) 200 located at a height of 15 cm. The infrared light was incident on the first main surface of the optical stack 100 at an incidence angle θi of about 15 to 20 degrees. A reader (F16 produced by Guanzhou Netum Electronic Technology Co., Ltd.) 300 having a detector thereof protected by a light-absorbing and infrared-transmissive filter 320 (IR filter produced by FUJIFILM Corporation) was disposed at a height of 15 cm and at a detection angle θd of 15 to 20 degrees. While the optical stack 100 was irradiated with the infrared light as described above, it was evaluated whether or not the QR code was read. An infrared image of the QR code was captured by a camera having a light receiver thereof protected by a light-absorbing and infrared-transmissive filter 420 (IR filter produced by FUJIFILM Corporation). The visual non-recognizability (concealability) of the QR code was evaluated based on whether or not the QR code was visually recognizable through the optical stack 100. Whether or not the design of the underlying layer was concealed by the optical stack 100 was evaluated by whether or not the QR code formed of the black ink was visually recognizable. In the case where the QR code is formed of visible light-transmissive ink, the QR code is not visually recognizable, needless to say.

Table 2 shows the evaluation results of comparative examples 1 through 7, and Table 3 shows the evaluation results of examples 1 through 11.

TABLE 2

| | | COMPAR- | COMPAR- | COMPAR- | COMPAR- | COMPAR- | COMPAR- | COMPAR- |
|---|---|---|---|---|---|---|---|---|
| | UNDERLYING | ATIVE | ATIVE | ATIVE | ATIVE | ATIVE | ATIVE | ATIVE |
| | LAYER | EX. 1 | EX. 2 | EX. 3 | EX. 4 | EX. 5 | EX. 6 | EX. 7 |
| QR CODE | A | GOOD | GOOD | POOR | POOR | POOR | POOR | POOR |
| READABILITY | B | GOOD | GOOD | POOR | POOR | POOR | POOR | POOR |
| | C | GOOD | GOOD | POOR | POOR | POOR | POOR | POOR |
| | D | POOR | POOR | POOR | POOR | POOR | POOR | POOR |
| | E | POOR | POOR | POOR | POOR | POOR | POOR | POOR |
| | F | POOR | POOR | POOR | POOR | POOR | POOR | POOR |
| | G | POOR | POOR | POOR | POOR | POOR | POOR | POOR |

| | | | | | | | |
|---|---|---|---|---|---|---|---|
| QR CODE VISUAL | POOR | GOOD | POOR | GOOD | POOR | POOR | POOR |
| NON-RECOGNIZABILITY | | | | | | | |
| FORWARD SCATTERING RATIO | 2.6 | 2.6 | 40.6 | 17.3 | — | — | — |
| FOR NEAR INFRARED (%) | | | | | | | |
| BACK SCATTERING RATIO | 3.4 | 3.4 | 48.5 | 48.5 | 41.4 | 18.6 | 10.4 |
| FOR NEAR INFRARED (%) | | | | | | | |
| FORWARD SCATTERING RATIO | 36.2 | 0.7 | 20.1 | 0.3 | — | — | — |
| FOR VISIBLE LIGHT (%) | | | | | | | |
| BACK SCATTERING RATIO | 47.7 | 47.7 | 75.4 | 75.4 | 56.6 | 19.9 | 11.4 |
| FOR VISIBLE LIGHT (%) | | | | | | | |

TABLE 3

| | UNDERLYING | | | | | | | | | | | |
|---|---|---|---|---|---|---|---|---|---|---|---|---|
| | LAYER | EX. 1 | EX. 2 | EX. 3 | EX. 4 | EX. 5 | EX. 6 | EX. 7 | EX. 8 | EX. 9 | EX. 10 | EX. 11 |
| QR CODE | A | GOOD | GOOD | GOOD | GOOD | GOOD | GOOD | GOOD | GOOD | GOOD | GOOD | GOOD |
| READABILITY | B | GOOD | GOOD | GOOD | GOOD | GOOD | GOOD | GOOD | GOOD | GOOD | GOOD | GOOD |
| | C | GOOD | GOOD | GOOD | GOOD | GOOD | GOOD | GOOD | GOOD | GOOD | GOOD | GOOD |
| | D | GOOD | GOOD | GOOD | GOOD | GOOD | GOOD | GOOD | GOOD | GOOD | GOOD | GOOD |
| | E | GOOD | GOOD | GOOD | GOOD | GOOD | GOOD | GOOD | GOOD | GOOD | GOOD | GOOD |
| | F | GOOD | GOOD | GOOD | GOOD | GOOD | GOOD | GOOD | GOOD | GOOD | GOOD | GOOD |
| | G | GOOD | GOOD | GOOD | GOOD | GOOD | GOOD | GOOD | GOOD | GOOD | GOOD | GOOD |

| | | | | | | | | | | | |
|---|---|---|---|---|---|---|---|---|---|---|---|
| QR CODE VISUAL | POOR | POOR | POOR | GOOD | GOOD | GOOD | POOR | POOR | GOOD | GOOD | POOR |
| NON-RECOGNIZABILITY | | | | | | | | | | | |
| FORWARD SCATTERING RATIO | 13.3 | 23.6 | 37.3 | 9.3 | 19.2 | 33.3 | 15.3 | 52.9 | 11.0 | 49.3 | 34.6 |
| FOR NEAR INFRARED (%) | | | | | | | | | | | |
| BACK SCATTERING RATIO | 3.4 | 3.9 | 4.8 | 3.4 | 3.9 | 4.8 | 3.7 | 8.0 | 3.7 | 8.0 | 7.0 |
| FOR NEAR INFRARED (%) | | | | | | | | | | | |
| FORWARD SCATTERING RATIO | 36.5 | 39.0 | 44.5 | 1.5 | 2.0 | 2.3 | 37.8 | 41.8 | 1.9 | 2.6 | 10.0 |
| FOR VISIBLE LIGHT (%) | | | | | | | | | | | |
| BACK SCATTERING RATIO | 31.8 | 32.2 | 31.8 | 31.8 | 32.2 | 31.8 | 31.2 | 34.3 | 31.2 | 34.3 | 56.6 |
| FOR VISIBLE LIGHT (%) | | | | | | | | | | | |

As can be understood from the results shown above, the optical stack in each of the examples, when disposed on an infrared-readable pattern formed on an underlying layer having a reflectance of 66% and a backscattering ratio of 19% for infrared light having a wavelength of 850 nm such that the second main surface S2 faces the pattern, enables the pattern to be read by the infrared light from the side of the first main surface S1. By contrast, the optical stack in each of the comparative examples is as follows. In a state of being disposed on an infrared-readable pattern formed on an underlying layer, such as paper or the like, having a high reflectance for infrared light having a wavelength of 850 nm such that the second main surface S2 faces the pattern, the optical stack enables the pattern to be read by the infrared light from the side of the first main surface S1. However, when disposed on an infrared-readable pattern formed on an underlying layer having a reflectance of 66% and a backscattering ratio of 19% for infrared light having a wavelength of 850 nm such that the second main surface S2 faces the pattern, the optical stack does not enable the pattern to be read by the infrared light from the side of the first main surface S1.

In addition, the optical stack in each of the examples enables an infrared-readable pattern to be read by the infrared light from the side of the first main surface S1, even where the pattern is formed on an underlying layer having a reflectance of 66% and a backscattering ratio of 10% for infrared light having a wavelength of 850 nm or is formed on an underlying layer having a reflectance of 66% and a backscattering ratio of 1% for infrared light having a wavelength of 850 nm. That is, the optical stack in each of the examples, when disposed on an infrared-readable pattern formed on any of various types of underlying layers, enables the pattern to be read by the infrared light.

The optical stack in each of the examples has a backscattering ratio that is lower than 10% for the near infrared light. The optical stack in each of the examples has a forward scattering ratio of 9% or higher for the near infrared light. An optical stack having a backscattering ratio that is lower than 10% and a forward scattering ratio of 9% or higher for the near infrared light, when disposed on an infrared-readable pattern formed on any of a further variety of types of underlying layers, enables the pattern to be read by the infrared light.

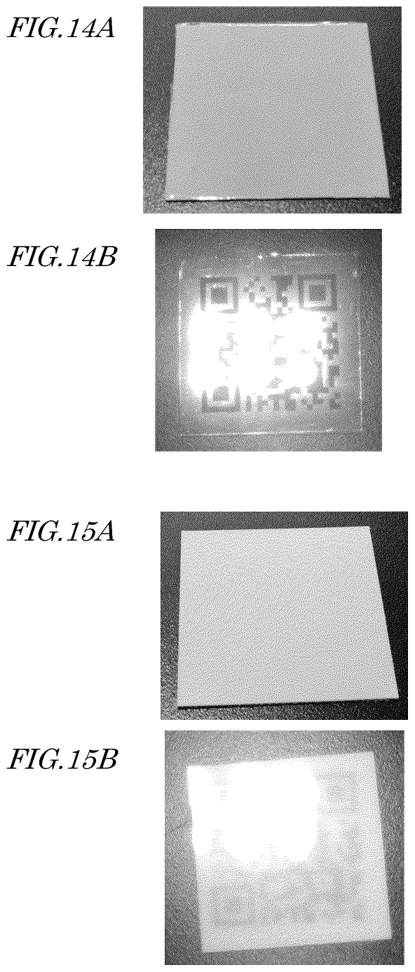

FIG. 14A shows an optical image of the optical stack in comparative example 2. FIG. 14B shows an infrared image of the QR code observed by an infrared camera through the optical stack in comparative example 2. FIG. 15A shows an optical image of the optical stack in comparative example 4. FIG. 15B shows an infrared image of the QR code observed by the infrared camera through the optical stack in comparative example 4. It is seen that the optical stack in each of comparative examples 2 and 4 has a high specular reflectance for the infrared light and thus does not enable the QR code to be read. With the optical stack in comparative example 4, the clarity of the QR code is low.

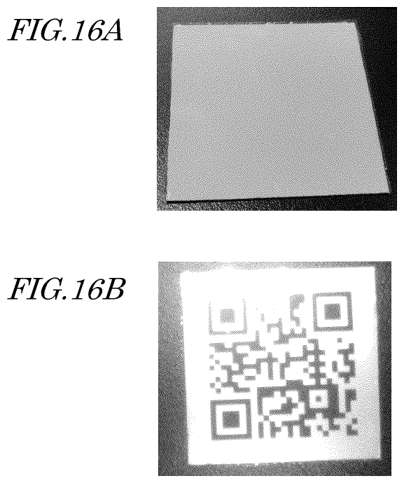

FIG. 16A shows an optical image of the optical stack in example 10. FIG. 16B shows an infrared image of the QR code observed by the infrared camera through the optical stack in example 10. It is seen that in the case where the optical stack in example 10 is used, the specular reflection for the infrared light is suppressed, and also the QR code is clearly observed.

In the optical image in each of FIG. 14A, FIG. 15A and FIG. 16A, the QR code on the underlying layer is not seen (in Table 2 and Table 3, the QR code visual non-recognizability is good). In order to provide a sufficient level of the QR code visual non-recognizability as in comparative example 2, comparative example 4 and example 10, it is preferred that the backscattering ratio for the visible light is 30% or higher and the forward scattering ratio for the visible light is 5% or lower, and it is more preferred that the forward scattering ratio for the visible light is 3% or lower.

### INDUSTRIAL APPLICABILITY

An optical stack according to an embodiment of the present invention, when disposed on an infrared-readable pattern formed on any of various types of underlying layers, enables the pattern to be read by infrared light. An optical stack according to an embodiment of the present invention further makes it difficult to visually recognize the pattern and thus enables any of various designs to be provided on the pattern. In the case where an optical stack according to an embodiment of the present invention is used, for example, a pattern (e.g., an AR marker) formed by use of toner (or ink) absorbing or reflecting infrared light on a surface of an item or on a building component (e.g., a wall, a floor, or a window), as well as on a recording medium layer formed of paper or the like, may enable any of various designs to be provided thereon.

### REFERENCE SIGNS LIST

100, 100A, 100B, 100C: optical stack; 110: optical filter layer; 120: diffusion layer; 130: visible light absorption layer, 140: decorative layer

1. An optical stack having a first main surface and a second main surface on the opposite side to the first main surface, the optical stack comprising:
an optical filter layer transmitting infrared light and reflecting visible light; and
a diffusion layer diffusing the visible light,
wherein when disposed on an infrared-readable pattern formed on an underlying layer having a reflectance of 66% and a backscattering ratio of 19% for infrared light having a wavelength of 850 nm such that the second main surface faces the pattern, the optical stack enables the pattern to be read by the infrared light from the side of the first main surface.

2. The optical stack of claim 1, wherein when disposed on an infrared-readable pattern formed on an underlying layer having a reflectance of 66% and a backscattering ratio of 10% for infrared light having a wavelength of 850 nm such that the second main surface faces the pattern, the optical stack enables the pattern to be read by the infrared light from the side of the first main surface.

3. The optical stack of claim 1, wherein when disposed on an infrared-readable pattern formed on an underlying layer having a reflectance of 66% and a backscattering ratio of 1% for infrared light having a wavelength of 850 nm such that the second main surface faces the pattern, the optical stack enables the pattern to be read by the infrared light from the side of the first main surface.

4. The optical stack of claim 1, wherein the optical stack has a backscattering ratio that is lower than 10% for near infrared light.

5. The optical stack of claim 1, wherein the optical stack has a forward scattering ratio of 9% or higher for near infrared light.

6. The optical stack of claim 1, further comprising a visible light absorbing layer transmitting the infrared light and absorbing the visible light.

7. The optical stack of claim 1, further comprising a decorative layer disposed on the side of the first main surface with respect to the optical filter layer.

8. The optical stack of claim 1, wherein the diffusion layer includes particles.

9. The optical stack of claim 1, wherein the optical stack has a backscattering ratio of 30% or higher for the visible light and a forward scattering ratio of 5% or lower for the visible light

10. The optical stack of claim 1, wherein the optical filter layer includes a visible light-transflective layer.

11. The optical stack of claim 1, wherein the optical filter layer has x and y coordinates respectively in the ranges of 0.25≤x≤0.40 and 0.25≤y≤0.40 on a CIE 1931 chromaticity diagram where the standard light is from a D65 light source.

12. The optical stack of claim 11, wherein the optical filter layer has a linear transmittance of 60% or higher for light having a wavelength in at least a part of the range that is not shorter than 760 nm but not longer than 2000 nm.

13. The optical stack of claim 11, wherein the optical filter layer includes a matrix and microparticles dispersed in the matrix, the microparticles acting as light-scattering mediums.

14. The optical stack of claim 11, wherein the microparticles form at least a colloidal amorphous array.
